(19) United States
(12) Patent Application Publication
(10) Pub. No.: US 2024/0210899 A1
(43) Pub. Date: Jun. 27, 2024

(54) SYNCHRONIZATION WITH MULTIPLE TIME SOURCES

(71) Applicant: Schweitzer Engineering Laboratories, Inc., Pullman, WA (US)

(72) Inventor: Daniel B. Rippon, Pullman, WA (US)

(73) Assignee: Schweitzer Engineering Laboratories, Inc., Pullman, WA (US)

(21) Appl. No.: 18/069,520

(22) Filed: Dec. 21, 2022

(51) Int. Cl. G04R 20/06; G01S 19/33

(52) U.S. Cl. CPC G04R 20/06; G01S 19/33

(57) ABSTRACT

A satellite-synchronized network clock may include an oscillator, a global navigation satellite system (GNSS) time receiver module, and a control subsystem. The GNSS time receiver module may include a time receiver, a multiplexer, and a plurality of source inputs. The control subsystem may configure the multiplexer and time receiver of the GNSS time receiver module to sequentially receive time signals from a plurality of GNSS satellite constellations. Methods of synchronizing multiple time sources may include sequentially receiving a first time signal from a first GNSS constellation, a second time signal from a second GNSS constellation, and a third time signal from a third GNSS constellation with a GNSS receiver. The methods may further include measuring a phase and frequency offset of each respective received time signal relative to an oscillator and comparing the measured offsets to determine the accuracy of each of the received time signals.

### TECHNICAL FIELD

This disclosure relates to systems, devices, and methods for synchronizing time for electronic devices. More particularly, but not exclusively, this disclosure relates to electronic devices with at least one timing receiver that is configured to synchronize to multiple time sources (e.g., multiple global navigation satellite system (GNSS) time sources).

### BRIEF DESCRIPTION OF THE DRAWINGS

Non-limiting and non-exhaustive embodiments of the disclosure are described, including various embodiments of the disclosure with reference to the figures, in which:

FIG. 1 is a block diagram of a clock system with a single time receiver subsystem configurable to sequentially receive time signals from multiple time sources according to an embodiment of the present disclosure.

FIG. 2 is a simplified process of multiplexing a single time receiver and tracking time from multiple sources, then comparing those sources to determining whether a source is acceptable, according to an embodiment of the present disclosure.

FIG. 3 is a block diagram of a clock system with a primary time receiver subsystem and a secondary time receiver subsystem configurable to sequentially receive time signals from multiple time sources according to an embodiment of the present disclosure.

FIG. 4 is a graph of a clock system's time tracking error to multiple sources with infrequent time synchronization events according to an embodiment of the present disclosure.

### DETAILED DESCRIPTION

Electric power systems generate, transmit, and distribute electric power to loads and serve as an important part of critical infrastructure. Electric power systems include equipment, such as generators, transmission and distribution lines, transformers, capacitor banks, and electrical substations, to provide electrical energy from sources to loads. In some cases, electric power systems and equipment may be monitored and protected by a variety of types of equipment. Such equipment may include sensors to monitor currents, voltages, phases, and other parameters of the electric power system. Such equipment may additionally include circuit breakers (CBs) to implement protective functions. The CBs may communicate with various other supervisory devices such as automation systems, monitoring systems, supervisory (SCADA) systems and other intelligent electronic devices (IEDs).

Many of these components of electric power systems accurately and reliably track time to improve function. Accordingly, time-keeping devices, such as satellite-synchronized network clocks, may be utilized to provide relatively accurate and reliable time. However, because satellite-synchronized network clocks rely on signals from a satellite constellation, if a signal from the satellite constellation becomes unreliable the time keeping of the satellite-synchronized network clock may become unreliable.

For cost, power, and size reasons, satellite-synchronized network clocks may have a limited number of GNSS receivers. Typically, a system includes only one or two GNSS receivers. However, it would greatly enhance the security and resiliency of the device to obtain timing information from as many satellite constellations as possible.

Each receiver may be capable of synchronizing to one of various GNSS satellite constellations. For example, each receiver may be capable of synchronizing to the Global Positioning System (GPS) satellite constellation, the Galileo satellite constellation, the Globalnaya Navigazionnaya Sputnikovaya Sistema, or Global Navigation Satellite System (GLONASS) satellite constellation, and/or the BeiDou (BDS) satellite constellation.

In one embodiment, a first receiver may be configured to synchronize to GPS as the primary receiver, and a second receiver may be configured to synchronize to GLONASS as an alternate receiver used to verify GPS (a satellite signal verification feature) in fixed configurations that do not change over time. The limitations of this arrangement are that with only two time sources available for comparison, the satellite signal verification feature can only determine that the two time sources do not agree. It cannot determine which time source is less accurate, or potentially malfunctioning or being manipulated (i.e., “off”) since it has no other information (e.g., three or more time sources to compare or “vote”).

Embodiments of the present disclosure may introduce information from 3 or more GNSS constellations (e.g., GPS, Galileo, GLONASS, and BDS) to resolve this limitation and allow the product to compare 3 or more of the available GNSS time sources with less than three dedicated GNSS receivers. Accordingly, embodiments of the present disclosure may be desirable to enhance the security of products having less than three dedicated GNSS receivers without the cost and labor of hardware retrofit to include additional GNSS receivers.

The embodiments of the disclosure will be best understood by reference to the drawings. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor do the steps need to be executed only once, unless otherwise specified.

In some cases, well-known features, structures, or operations are not shown or described in detail. Furthermore, the described features, structures, or operations may be combined in any suitable manner in one or more embodiments. It will also be readily understood that the components of the embodiments, as generally described and illustrated in the figures herein, could be arranged and designed in a wide variety of different configurations. For example, throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Several aspects of the embodiments disclosed herein may be implemented as software modules or components. As used herein, a software module or component may include any type of computer instruction or computer-executable code located within a memory device that is operable in conjunction with appropriate hardware to implement the programmed instructions. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. Indeed, a module or component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a non-transitory machine-readable medium having stored thereon instructions that may be used to program a computer or other electronic device to perform processes described herein. The non-transitory machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable media suitable for storing electronic instructions. In some embodiments, the computer or another electronic device may include a processing device such as a microprocessor, microcontroller, logic circuitry, or the like. The processing device may further include one or more special purpose processing devices such as an application specific interface circuit (ASIC), PAL, PLA, PLD, field programmable gate array (FPGA), or any other customizable or programmable device.

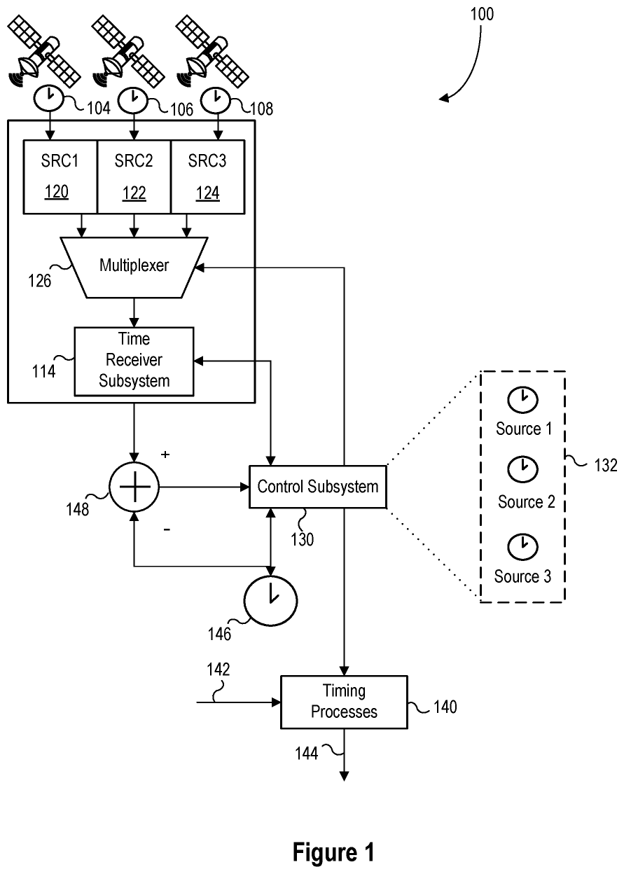

FIG. 1 shows a block diagram for a clock system 100 (e.g., a satellite-synchronized network clock system), according to an embodiment of the present disclosure, with a single time receiver subsystem 114 that is configurable to sequentially receive time signals from multiple time sources 104, 106, 108 (e.g., GNSS constellations). A multiplexer 126 may selectively connect the time receiver subsystem 114 to a plurality of GNSS constellations 104, 106, and 108. Each GNSS constellation 104, 106, 108 may be considered a separate time source (e.g., a first source input 120, a second source input 122, and a third source input 124). For example, the first source input 120 may be configured to receive a GPS constellation time signal 104, the second source input 122 may be configured to receive a GLONASS constellation time signal 106, and the third source input 124 may be configured to receive a Galileo constellation time signal 108. One of the inputs of multiplexer 126 may be selectively connected to time receiver subsystem 114 based on a select signal from control subsystem 130.

Control subsystem 130 may be programmed and configured to selectively connect one of the plurality of time sources 104, 106, 108 to the time receiver subsystem 114. The clock system 100 may then receive time signals from the time receiver subsystem 114 corresponding to the selected time source 104, 106, 108 and measure a drift rate or offset with respect to a local oscillator 146 and/or other time sources. The control subsystem 130 may then re-configure the time receiver subsystem 114 for the next desired time source 104, 106, 108, measure and calculate its time and frequency offsets, and so on (e.g., in a sequential and cyclical manner) for all desired time sources 104, 106, 108.

For example, at a first time the control subsystem 130 may configure the time receiver subsystem 114 to receive a GPS constellation time signal 104 and may configure the multiplexer 126 to direct the GPS constellation time signal 104 from the first source input 120 to the time receiver subsystem 114. At a second time, after the first time, the control subsystem 130 may configure the time receiver subsystem 114 to receive a GLONASS constellation time signal 106 and may configure the multiplexer 126 to direct the GLONASS constellation time signal 106 from the second source input 122 to the time receiver subsystem 114. At a third time, after the second time, the control subsystem 130 may configure the time receiver subsystem 114 to receive a Galileo constellation time signal 108 and may configure the multiplexer 126 to direct the Galileo constellation time signal 108 from the third source input 124 to the time receiver subsystem 114.

The control subsystem 130 may store these measurements in a memory 132 and the control subsystem 130 may then maintain a continuous estimate of each time source's time by using the previous measurements stored in the memory 132 relative to its local oscillator 146. Using time information from all available time sources, the clock system 100 can make decisions on the acceptability of the available time sources, generate and report diagnostics, and generate time signals from downstream consumption. Additionally, with this information a reliably accurate system time may be determined.

Local oscillator 146 may be compared to the various GNSS constellations by comparator 148. A difference between each of the GNSS constellation time sources 120, 122, and 124, may be compared to the local time source 146. The difference may be tracked by control subsystem 130. Control subsystem 130 may determine a drift rate and/or offset between each of the GNSS constellation time sources 120, 122, and 124. The determined drift rate and/or offset may be used, among other things, by system 100 to determine whether any of the GNSS constellation time sources 120, 122, and 124 are unreliable. For example, a rapid change in the drift rate and/or offset may be indicative of spoofing or other potentially malicious acts or problems with a particular GNSS constellation. When a time signal from one of the plurality of GNSS constellations exceeds a threshold in comparison to a tracked metric (e.g., a drift rate, an offset, an Allan deviation, etc.) the GNSS constellation may be excluded from use by timing processes 140.

During typical operation, system 100 may utilize one or more of the GNSS constellation time sources 120, 122, and 124 to perform time-dependent functionality in a larger system (e.g., an electric power system). The timing processes 140 may include inputs 142 to receive user inputs and inputs from other system components, and outputs 144 to provide time signals to other system components and perform time- dependent operations, such as system diagnostics and maintenance. If problems with one GNSS constellation is detected, system 100 may exclude a time signal from that constellation until the problem is resolved. During such periods, clock system 100 may continue to monitor the problematic constellation, but timing processes 140 may exclusively utilize the other GNSS constellation time signals.

Accordingly, a single time receiver subsystem 114 may be used to track time from multiple GNSS constellations by synchronizing to each desired constellation in sequential fashion, with the control subsystem 130 then maintaining an estimate of each constellation's time using a calculation of its local oscillator 146 and previous drift rate and offsets from each respective time source 104, 106, 108. Timing security and resiliency can then be enhanced by using information from all available time sources.

In various embodiments, time synchronization may occur at approximately fixed intervals, such as a once-per-second update from a GNSS receiver, IEEE Std 1588 Precision Time Protocol (PTP) source, or IRIG-B source (i.e., a source using the Inter-Range Instrumentation Group (IRIG) time code “B” standard format). The interval of the synchronization is primarily determined by the expected stability of the internal oscillator of the device to be synchronized, and the desired time accuracy to be maintained. For example, a device with a hypothetical perfect internal oscillator would only need to be synchronized once to forever maintain time, while a device with a more typical oscillator might have a frequency stability of 1E-8 Hz/Hz (10 parts per billion) over 100 seconds and would utilize a time update frequency of approximately once per ten seconds or faster to maintain timing to within 100 ns accuracy.

Considering the stability of the clock system 100′s internal oscillator 146, the clock system 100 can multiplex between the multiple time sources 104, 106, 108 with the timing receiver subsystem 114 and maintain a continuous estimation of each time source 104, 106, 108 within an accuracy determined by the stability of the internal oscillator 146 and the duration between successive synchronization events to each source 104, 106, 108. In this context, “synchronization” can be virtual rather than physical, and only requires obtaining time and frequency information of a time source 104, 106, 108 such that the source's time and frequency could be recreated or compared to other sources from that information.

For example, with a 1E-8 stability oscillator, and a time period of 10 seconds between two synchronization events to independent sources, the timing can be compared between the two time sources with an introduced inaccuracy of less than 100 ns. With higher stability oscillators like those used in dedicated timing products such as satellite-synchronized network clocks, the time duration between synchronization events and/or the expected accuracy is greatly improved, and the device may only require synchronization to a time source once per hour while still maintaining timing specifications required by end-applications.

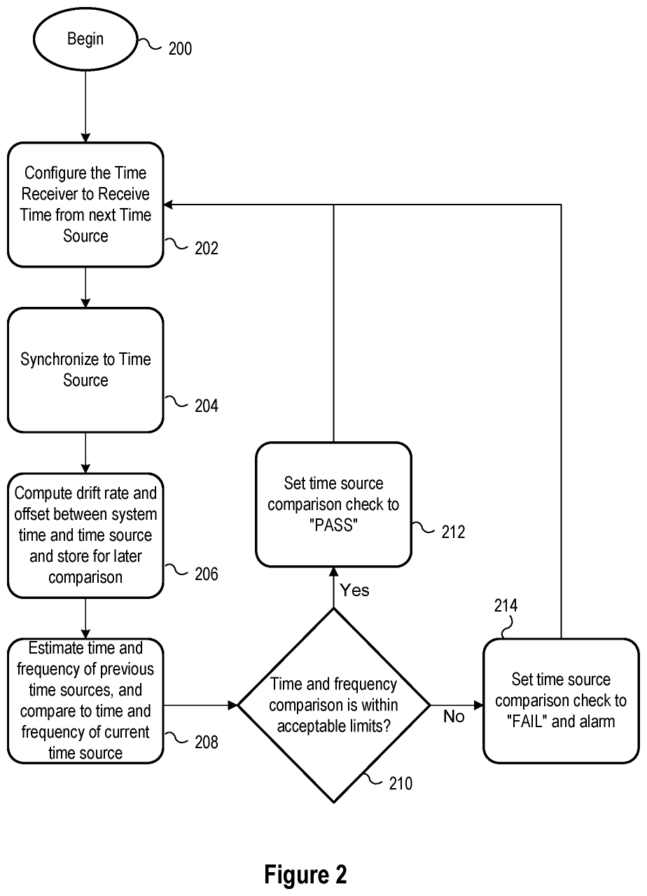

Using a single receiver to track time from multiple sources (as described above), the time from those sources can be compared and used to verify the integrity of the available time sources. FIG. 2 shows a simplified process, according to an embodiment of the present disclosure, of multiplexing a single time receiver and tracking time from multiple sources, then comparing those sources to determine whether a source is acceptable.

As shown in FIG. 2, from the beginning step 200 the process may involve the step 202 of configuring the time receiver to receive time from a next time source. For example, a control subsystem may configure a multiplexer and a time receiver to receive a time signal from a specific time source, such as a GNSS satellite constellation, and the time source selected may change sequentially and cyclically each time the process goes through step 202.

At the next step 204 in the process, the clock system may be synchronized to the selected time source. Next, at step 206, a time and frequency offset may be computed between the clock system time and the selected time source and stored for later comparison. For example, a control subsystem may compute the time and frequency offset between the clock system time and the selected time source and stored the computed time and frequency offset in a memory device for later comparison by the control subsystem.

Next, at step 208, the stored time and frequency of previously computed and stored computed time and frequency offset between the clock system time and the previously selected time source may be compared to the stored computed time and frequency offset between the clock system time and the currently selected time source. For example, the control subsystem of the clock system may retrieve the stored computed time and frequency offset between the clock system time and the previously selected time source may be compared to the stored computed time and frequency offset between the clock system time and the currently selected time source from the memory and compare the stored time and frequency offsets.

At step 210, it may be determined whether the compared time and frequency offsets are within acceptable limits. For example, the control subsystem of the clock system may determine the difference between the stored computed time and frequency offset between the clock system time and the previously selected time source and the stored computed time and frequency offset between the clock system time and the currently selected time source. If the difference is within a range of predetermined stored values, the control subsystem may determine that the compared time and frequency offsets are within acceptable limits. Similarly, if the difference is outside of a range of predetermined stored values, the control subsystem may determine that the compared time and frequency offsets are not within acceptable limits.

If it is determined at step 210 that the compared time and frequency offsets are within acceptable limits, the process may proceed to step 212. At step 212, the time source comparison check may be set to “PASS” and the system may continue in a normal fashion. The system may proceed with utilizing the time received from the currently selected time source in determining the clock system time.

If it is determined at step 210 that the compared time and frequency offsets are not within acceptable limits, the process may proceed to step 214. At step 214, the time source comparison check may be set to “FAIL” and the system may issue an alarm indicating that the currently selected time source may be unreliable. The system may proceed without utilizing the time received from the currently selected time source and rely only on time from previously selected time sources and the internal oscillator in determining the clock system time.

After either of steps 212 or 214, the process may restart at step 202 and the process may continue in a cyclical manner with multiple time sources being individually selected in a sequential manner.

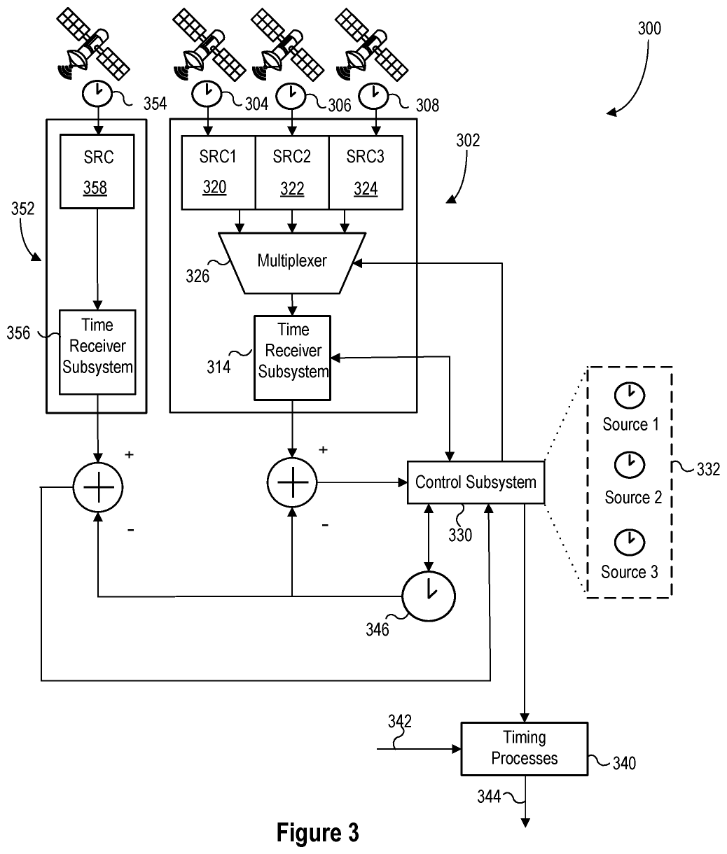

FIG. 3 shows a block diagram for a clock system 300 (e.g., a satellite-synchronized network clock system) according to an additional embodiment of the present disclosure with a primary time receiver 352 that may be configured to receive time signals from a single time source 354 (e.g., a GNSS time source) and a secondary time receiver module 302 that is configurable to sequentially receive time signals from multiple time sources 304, 306, 308 (e.g., GNSS time sources).

The primary time receiver 352 may include a single time receiver subsystem 356 and a single source input 358 that may be configured to receive time signals from a single primary time source 354, such as from a GPS satellite constellation.

The secondary time receiver module 302 may include a single time receiver subsystem 314 and a multiplexer 326. System 300 may receive plurality of time signals 304, 306, and 308. Each of the sources 320, 322, 324 may be configured to receive a time signal from a different time source 304, 306, 308, such as from a different GNSS time source. For example, the first source input 320 may be configured to receive a GLONASS constellation time signal 304, the second source input 322 may be configured to receive a Galileo constellation time signal 306, and the third source input 324 may be configured to receive a BDS constellation time signal 308.

Inputs of the multiplexer 326 may be coupled with each of the source inputs 320, 322, 324, respectively, and an output of the multiplexer 326 may be coupled with the time receiver subsystem 314. Accordingly, the multiplexer 326 may be configured to selectively send time signals 304, 306, 308 from each of the source inputs 320, 322, 324 to the time receiver subsystem 314.

A control subsystem 330 may be configured to select the desired time source 304, 306, 308 by configuring the multiplexer 326 and time receiver subsystem 314 appropriately. The clock system 300 may then receive time signals from the time receiver subsystem 314 corresponding to the selected time source 304, 306, 308 and measure and calculate a drift rate and/or offsets to a local oscillator 346 (e.g., an internal oscillator) and/or other time sources. The control subsystem 330 may then re-configure the time receiver subsystem 314 for the next desired time source 304, 306, 308, measure and calculate its time and frequency offsets, and so on (e.g., in a sequential and cyclical manner) for all desired time sources 304, 306, 308.

For example, at a first time the control subsystem 330 may configure the secondary time receiver subsystem 314 to receive a GLONASS constellation time signal 304 and may configure the multiplexer 326 to direct the GLONASS constellation time signal 304 from the first source input 320 to the time receiver subsystem 314. At a second time, after the first time, the control subsystem 330 may configure the time receiver subsystem 314 to receive a Galileo constellation time signal 306 and may configure the multiplexer 326 to direct the Galileo constellation time signal 306 from the second source input 322 to the time receiver subsystem 314. At a third time, after the second time, the control subsystem 330 may configure the time receiver subsystem 314 to receive a BDS constellation time signal 308 and may configure the multiplexer 326 to direct the BDS constellation time signal 308 from the third source input 324 to the time receiver subsystem 314.

Meanwhile, the clock system 300 may receive time signals from the time receiver subsystem 356 of the primary time receiver module 352 from the primary time source 354, such as a GPS constellation time signal. The clock system 300 may then measure and calculate time and/or frequency offsets to the oscillator 346 and/or other time sources.

The control subsystem 330 can store each of these measurements in a memory 332 and the control subsystem 330 can then maintain a continuous estimate of each time source's time (e.g., by using the previous measurements stored in the memory 332 and its local oscillator 346). Using time information from all available time sources, the clock system 300 can make decisions on the acceptability (i.e., accuracy) of the available time sources, generate and report diagnostics, and generate time signals from downstream consumption. Additionally, with this information a reliably accurate clock system time may be determined.

The clock system time determined by the control subsystem 330 may then be utilized by one or more timing processes module 340 to perform time dependent functionality in a larger system (e.g., an electric power system management system). The timing processes module 340 may include an input 342 to receive user inputs and inputs from other system components, and outputs 344 to provide time signals to other system components and perform time dependent operations, such as system diagnostics and maintenance.

In the example above, a single time source (e.g., GPS) may be selected as the preferred primary time source to derive the clock system time, while the alternate time sources (e.g., GLONASS, Galileo, BDS, or other), may be used to verify the integrity of the primary time source. In some embodiments, it may be desired to failover to one of the alternate time sources if the primary time source is not available or it is determined to not be suitable (via the integrity check or otherwise). In this case, the clock system time may be derived or maintained from one of the alternate time sources.

In embodiments with two time receivers, the primary time receiver may be reconfigured from the preferred time source to an alternate time source (to reduce error through continuous synchronization). The preferred time source may then be monitored with the remaining alternate time sources, and once recovered, the system may revert back to the preferred time source.

Some embodiments of the present disclosure may include multiple time receivers, each with its own capabilities to synchronize over different media and protocols. For example, a system with two GNSS time receivers, each capable of synchronizing to one of four GNSS constellations may be used in conjunction with an ethernet-based time receiver capable of synchronizing to network-time-protocol (NTP) and PTP sources, and additionally a time receiver capable of synchronizing to both an IRIG-B or one pulse-per-second (1 PPS) signal over coaxial cable. In this way, embodiments of the present disclosure could also be used in a variety of products requiring secure and resilient time synchronization.

In some embodiments, each time receiver of a clock system may be configured to receive time from one of multiple time sources based on a variety of factors such as user preferences, user-set priorities, expected or measured performance of the time source, requirements of the time source's protocol, time quality data received from the time source, status and availability of other time sources, environmental conditions, and other factors.

Based off these factors, the clock system may synchronize to or measure certain time sources more or less frequently, or for longer or shorter durations, or may choose to synchronize to certain time sources only when certain conditions are met. This is in contrast to additional embodiments, which may synchronize to each time source with roughly equal priority.

In conjunction with multiplexing between multiple time sources and maintaining an estimate of those time scales, a variety of time source comparison and integrity verification methods may be used.

In some embodiments, the timing phase between one or more sources may be compared. In additional embodiments, the frequency offset between one or more sources or the local oscillator may be compared. In further embodiments, a statistic for the measured time or phase offset such as a standard deviation of the phase offsets, or the Allan deviation of the frequency, or a time-based average or other statistic may be computed, and compared to user-set thresholds, or compared to computed thresholds or conditions based off historical data. When a time signal from one of the plurality of GNSS constellations exceeds a threshold in comparison to a tracked metric (e.g., a drift rate, an offset, an Allan deviation, etc.) the GNSS constellation may be excluded from use by timing processes.

In additional embodiments, the data messages of the multiple time sources may be compared to user-defined data, and/or to externally gathered data. Comparison of such data typically contains information such as Universal Time Coordinated (UTC) offsets, pending leap second information, time source information, satellite orbit ephemeris, satellite constellation clock offsets, and other data associated with the time sources. In further embodiments, the ranging measurements or timestamps associated with the time sources, GNSS pseudoranges, timestamps associated with PTP messages, or measurements of cabling using time-domain reflectometry may be compared.

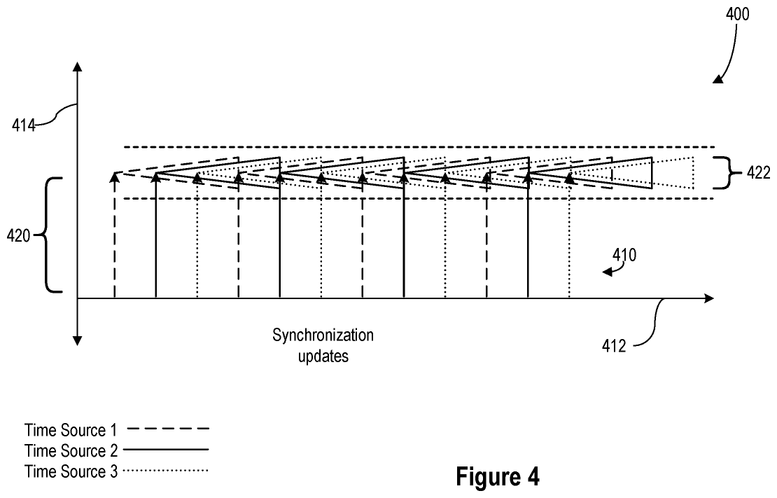

FIG. 4 shows a graph 400 of a device's time tracking error to multiple sources with infrequent time synchronization events 410, such as due to a single time receiver multiplexing between multiple time sources. The graph 400 includes a horizontal axis 412 indicating synchronization updates over time, and a vertical axis 414 indicating an error magnitude of the synchronization updates. A portion 420 of the error is due to the time source's quality (accuracy of the time source) and the ability of the time receiver to synchronize accurately with that time source. When the synchronization event occurs, the clock system has the most precise reading of that source's time, and a corresponding time tracking error 422 is very small, with no error incurred due to its internal oscillator stability. As time elapses between synchronization events from that time source, the clock system's time tracking error 422 grows due to the instability of its internal oscillator. If the maximum expected time tracking errors 422 are acceptable, multiple sources can be reliably used with infrequent time updates.

While specific embodiments and applications of the disclosure have been illustrated and described, it is to be understood that the disclosure is not limited to the precise configurations and components disclosed herein. Accordingly, many changes may be made to the details of the above-described embodiments without departing from the underlying principles of this disclosure. The scope of the present invention should, therefore, be determined only by the following claims.

What is claimed is:

1. A time synchronization system, comprising:
a global navigation satellite system (GNSS) subsystem comprising:
a source input to connect to a plurality of GNSS constellations and receive GNSS time signals from each of the plurality of GNSS constellations; and
a time receiver subsystem to receive the GNSS time signals using the source input,
a local oscillator to generate a local time signal; and
a control subsystem to:
sequentially connect to each of the plurality of GNSS constellations and receive GNSS time signals from each of the plurality of GNSS constellations;
track at least one of a drift rate and an offset between the GNSS time signals from each of the plurality of GNSS constellations and the local time signal;
evaluate the GNSS time signals from each of the plurality of GNSS constellations against the local oscillator and local time signal based on at least one of the drift rate and the offset; and
generate an output based on at least one GNSS time signal from at least one of the plurality of GNSS constellations.

2. The time synchronization system of claim 1, wherein the control subsystem is configured to exclude one of the plurality of GNSS constellations when at least one of the drift rate and the offset exceeds a threshold.

3. The time synchronization system of claim 1, wherein the control subsystem is configured to maintain a continuous estimate of at least one of the drift rate and the offset of the GNSS time signals from each of the plurality of GNSS constellations by comparing at least one of a present drift rate and present offset to a previous measurement.

4. The time synchronization system of claim 1, wherein the GNSS subsystem is configured to sequentially receive GNSS time signals from at least three GNSS satellite constellations.

5. The time synchronization system of claim 4, wherein the GNSS subsystem is configured to sequentially receive GNSS time signals from three GNSS satellite constellations selected from a Global Positioning System (GPS) satellite constellation, a Galileo satellite constellation, a Globalnaya Navigazionnaya Sputnikovaya Sistema, or Global Navigation Satellite System (GLONASS) satellite constellation, and a BeiDou (BDS) satellite constellation.

6. The time synchronization system of claim 1, wherein the output provides nano-second accuracy.

7. The time synchronization system of claim 1, wherein the system is comprised within an intelligent electronic device for use in an electric power system.

8. A time synchronization system, comprising:
a global navigation satellite system (GNSS) subsystem comprising:
a first source input to connect to a plurality of GNSS constellations and receive GNSS time signals from each of the plurality of GNSS constellations; and
a second source input to connect to a primary GNSS constellation and receive primary GNSS time signals from the primary GNSS constellation; and
a control subsystem to:
sequentially connect the first source input to each of the plurality of GNSS constellations and receive GNSS time signals from each of the plurality of GNSS constellations;
generate an evaluation of the GNSS time signals from each of plurality of GNSS constellations; and
generate an output selected between the GNSS time signals from one of the plurality of GNSS constellations and the primary GNSS time signals based on the evaluation.

9. The time synchronization system of claim 8, wherein the control subsystem is configured to maintain a continuous estimate of at least one of a drift rate and an offset of the GNSS time signals from each of the plurality of GNSS constellations and the primary GNSS time signals by comparing at least one of a present drift rate and present offset to a previous measurement.

10. The time synchronization system of claim 9, wherein the control subsystem is configured to exclude one of the plurality of GNSS constellations when at least one of the drift rate and the offset exceeds a threshold.

11. The time synchronization system of claim 8, wherein the GNSS subsystem is configured to sequentially receive GNSS time signals from at least two additional GNSS satellite constellations in addition to the primary GNSS constellation.

12. The time synchronization system of claim 11, wherein the additional GNSS satellite constellations comprise at least two GNSS satellite constellations selected from a Galileo satellite constellation, a Globalnaya Navigazionnaya Sputnikovaya Sistema, or Global Navigation Satellite System (GLONASS) satellite constellation, and a BeiDou (BDS) satellite constellation.

13. The time synchronization system of claim 8, wherein the primary GNSS constellation comprises a Global Positioning System (GPS).

14. The time synchronization system of claim 13, wherein the control subsystem is configured to maintain a continuous estimate of at least one of a drift rate and an offset of the GNSS time signals from each of the plurality of GNSS constellations and the primary GNSS time signals by comparing at least one of a present drift rate and a present offset to a local oscillator and local time signals.

15. The time synchronization system of claim 8, wherein the control subsystem is configured to exclude one of the plurality of GNSS constellations when at least one of a drift rate and an offset exceeds a threshold.

16. The time synchronization system of claim 8, wherein the control subsystem is configured to evaluate the GNSS time signals by at least one of: a comparison of the GNSS time signals from each of plurality of GNSS constellations against a local oscillator; a comparison of phase offset or frequency between sources; a comparison to a statistic computed based on historical measurements; a comparison of data messages of the GNSS time sources; a comparison of data messages of GNSS time sources to externally gathered data; and a comparison of data messages or timing phase or frequency of the GNSS sources to other time sources.

17. A method of time synchronization, comprising:
providing a global navigation satellite system (GNSS) subsystem comprising a source input to connect to a plurality of GNSS constellations and receive GNSS time signals from each of the plurality of GNSS constellations;
providing a local oscillator to generate a local time signal;
sequentially connecting the source input to each of the plurality of GNSS constellations and receiving GNSS time signals from each of the plurality of GNSS constellations;
tracking at least one of a drift rate and an offset between the GNSS time signals from each of the plurality of GNSS constellations and the local time signal;
evaluating the GNSS time signals from each of plurality of GNSS constellations; and
generating an output based on at least one time signal from one of the plurality of GNSS constellations.

18. The method of claim 17, further comprising excluding one of the plurality of GNSS constellations when at least one of the drift rate and the offset exceeds a threshold.

19. The method of claim 17, further comprising sequentially receiving time signals from at least three GNSS satellite constellations.

20. The method of claim 17, wherein the output provides nano-second accuracy.

21. The method of claim 17, wherein evaluating the GNSS time signals from each of plurality of GNSS constellations comprises comparing the GNSS time signals from each of plurality of GNSS constellations to at least one of: a local oscillator; a phase offset or frequency between sources; a statistic computed based on historical measurements; data messages of the GNSS time sources; a comparison of data messages of GNSS time sources to externally gathered data; and a comparison of data messages or timing phase or frequency of the GNSS sources to other time sources.
